(19) United States
(12) Patent Application Publication
(10) Pub. No.: US 2014/0156715 A1
(43) Pub. Date: Jun. 5, 2014

(54) FILE UPLOADING SYSTEM AND METHOD

(71) Applicants: Hon Hai Precision Industry Co., Ltd., New Taipei (TW); Hong Fu Jin Precision Industry (ShenZhen) Co., Ltd., Shenzhen (CN)

(72) Inventors: CHUNG-I LEE, New Taipei (TW); DE-YI XIE, Shenzhen (CN); JIE HUANG, Shenzhen (CN)

(73) Assignees: Hon Hai Precision Industry Co., Ltd., New Taipei (TW); Hong Fu Jin Precision Industry (ShenZhen) Co.,, Shenzhen (CN)

(21) Appl. No.: 13/974,160

(22) Filed: Aug. 23, 2013

(30) Foreign Application Priority Data
Dec. 4, 2012 (CN) 2012105106624

(51) Int. Cl. G06F 17/30

(52) U.S. Cl. CPC G06F 17/30194
USPC 707/827

(57) ABSTRACT

A monitoring computer is electronically connected to a data center that includes a plurality of cloud servers. The monitoring computer calculates a priority coefficient of each cloud server according to parameters of the cloud servers. The monitoring computer generates a priority list and saves the calculated priority coefficients into the priority list. The monitoring computer selects one cloud server that has a minimal priority coefficient in the priority list, and saving a file uploaded by a client into the selected cloud server.

### BACKGROUND

1. Technical Field

The embodiments of the present disclosure relate to cloud computing technology, and particularly to a file uploading system and method via cloud computing.

2. Description of Related Art

A data center is a facility which houses a large number of servers and stores huge amounts of data (e.g., files). When <<I assume this is a new sentence>> a user uploads a file into the data center, a server is selected from the large number of servers for saving the file. However, the data center may not know which server is uploading the file, and if the computer is slow or non-responsive the file may be not successfully uploaded into the selected computer. Thus, there is room for improvement in the art.

### BRIEF DESCRIPTION OF THE DRAWINGS

FIG. 1 is a system view of one embodiment of a file uploading system.

FIG. 2 is a block diagram of function modules of one embodiment of a monitoring server included in FIG. 1.

FIG. 3 is a flowchart of one embodiment of a file uploading method.

FIG. 4 illustrates a priority coefficient list.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

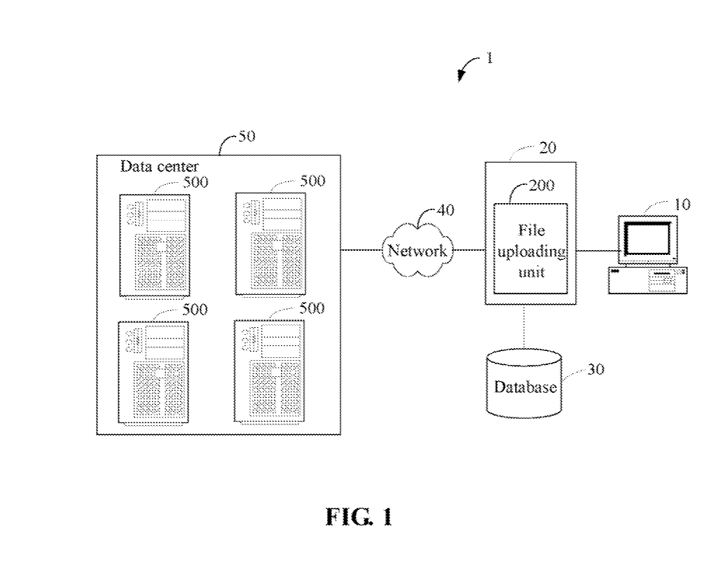

FIG. 1 is a block diagram of one embodiment of a file uploading system 1. In one embodiment, the file uploading system 1 may include one or more clients 10, a monitoring computer 20, a database 30, a network 40, and a data center 50. The data center 50 is designed for cloud computing capability and capacity and includes a plurality of cloud servers 500. The file uploading system 1 may be used to efficiently select a cloud server 500 from the data center 50 for saving a file which is uploaded from the client 10 by a user.

The data center 50 is located behind a firewall, and is connected to the network 40. The network 40 may be, but is not limited to, a wide area network (e.g., the Internet) or a local area network. The firewall is used to protect the data center 50 from unauthorized access and secure information of the data center 50.

The monitoring computer 20 is connected to the data center 50 and is capable of accessing each cloud server 500. In one embodiment, the monitoring computer 20 may be a personal computer (PC), a network server, or any other data-processing equipment. Further details of the monitoring computer 20 will be described below.

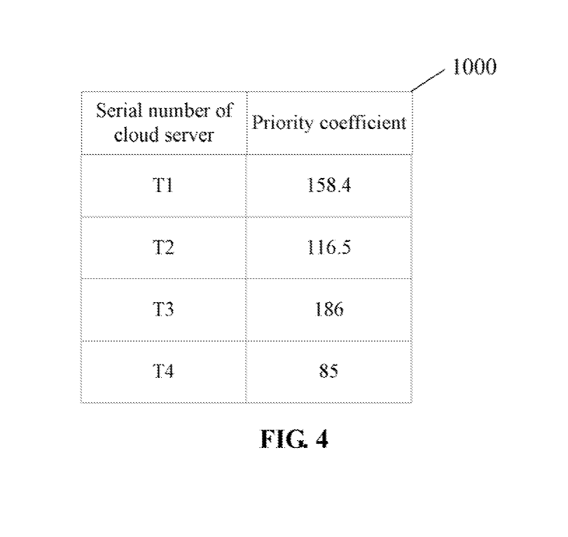

The database 30 is connected to the monitoring computer 20 using open database connectivity (ODBC) or java database connectivity (JDBC), for example. The database 30 may store parameters of each cloud server 500. The parameters of each cloud server 500 includes a total storage (e.g., two TB) of the cloud server 500, an available storage (e.g., one TB) of the cloud server 500, a memory utilization rate (e.g., 30%, a percentage capacity usage of a memory) of the cloud server 500, a CPU utilization rate (e.g., 80%, a percentage capacity usage of a CPU) of the cloud server 500, a continuous operation time (e.g., two days) of the cloud server 500, a total number (e.g., ten files) of files stored in the cloud server 500, and a usage storage of the files stored in the cloud server 500. The database 30 also stores a priority coefficient list 1000 as shown in FIG. 4. The priority coefficient list 1000 includes serial numbers and priority coefficients of the cloud server 500, for example, a cloud server 500 may be assigned a serial number T1 and a priority coefficient 158.4, which are stored in the priority coefficient list.

The client 10 is connected to the monitoring computer 20. The client 10 may be a personal computer (PC), a network server, or any item of other data-processing equipment. In one embodiment, the client 10 may provide a user interface, which is displayed on a display device of the client 10, for a user to control one or more operations of the monitoring computer 20. The user may input an ID (e.g., a username) and a password by an input device (e.g., a keyboard) of the client 10 into the user interface, to access the monitoring computer 20.

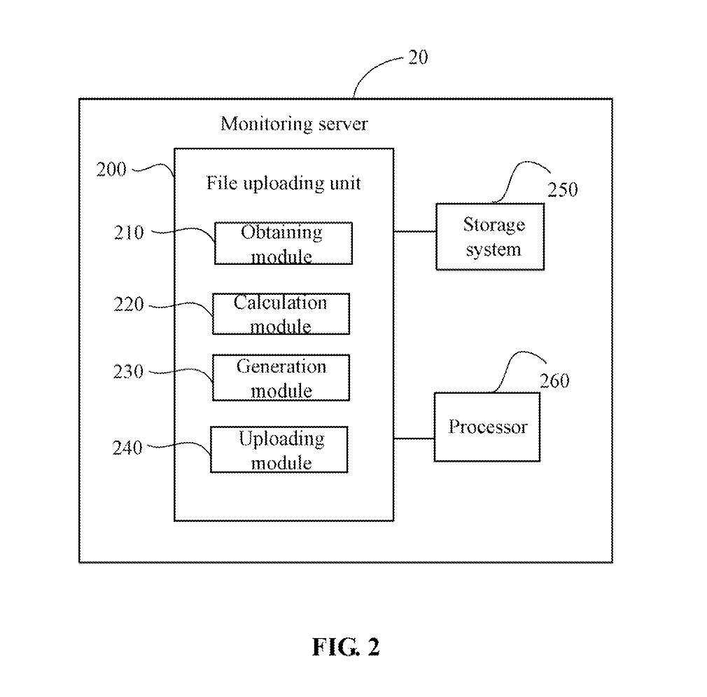

FIG. 2 is a block diagram of function modules of one embodiment of the monitoring computer 20. The monitoring computer 20 includes a file uploading unit 200. In one embodiment, the monitoring computer 20 includes a storage system 250, and at least one processor 260. In one embodiment, the file uploading unit 200 includes an obtaining module 210, a calculation module 220, a generation module 230, and an uploading module 240. The modules 210-240 may include computerized code in the form of one or more programs that are stored in a storage system 250. The computerized code includes instructions that are executed by the at least one processor 260 to provide functions for the modules 210-240. The storage system 250 may be a memory, such as an EPROM memory chip, HDD, or flash memory stick.

The obtaining module 210 obtains the parameters of each cloud server 500. In one embodiment, each cloud server 500 is installed with an operating system, and the parameters of each cloud server 500 are collected by a task manager of the operating system. The obtaining module 210 obtains the parameters of each cloud server 500 from the task manager of the operating system installed in the cloud server 500. Additionally, the parameters of each cloud server 500 are obtained at a time interval (e.g., one day).

The calculation module 220 calculates a priority coefficient of each cloud server 500 according to the obtained parameters of each cloud server 500. In one embodiment, the priority coefficient indicates a priority for saving a file. The greater the priority coefficient is, the more loads the cloud server 500 has. The priority coefficient of the cloud server 500 is calculated by a formula as follows: H=[(B/A)+C+D]*(M+N+P), where H represents the priority coefficient, B represents the available storage of the cloud server 500, A represents the total storage of the cloud server 500, C represents the memory utilization rate of the cloud server 500, D represents the CPU utilization rate of the cloud server 500, M represents the continuous operation time of the cloud server 500, N represents the total number of files stored in the cloud server 500, and P represents the usage storage of the files stored in the cloud server 500. For example, assuming that the available storage of the cloud server 500 is three hundred GB, the total storage of the cloud server 500 is six hundred GB, the memory utilization rate of the cloud server 500 is 40%, the CPU utilization rate of the cloud server 500 is 30%, the continuous operation time of the cloud server 500 is twelve days, there are total one hundred files stored in the cloud server 500, and twenty GB usage storage of the cloud server 500 has been used for storing the one hundred files, then the priority coefficient of the cloud server 500 is calculated as follows:

[(300/600)+40%+30%]*(12+100+20)=158.4.

The generation module 230 generates the priority list 1000 and saves the calculated priority coefficient into the priority list 1000. As shown in FIG. 4, four priority coefficients are calculated and saved into the priority list 1000. Additionally, the priority list 1000 is updated in real time. For example, if the priority coefficient of the cloud server T1 is changed to 123.4, the priority coefficient 158.4 in the priority list 1000 is replaced by the priority coefficient 123.4.

The uploading module 240 selects one cloud server 500 from the data center 50 for saving a file which is uploaded from the client 10 by a user. In one embodiment, the uploading module 240 searches for a minimum priority coefficient in the priority list 1000, and selects the cloud server 500 corresponding to the minimum priority coefficient. The file is preferentially saved into the cloud server 500 corresponding to the minimum priority coefficient.

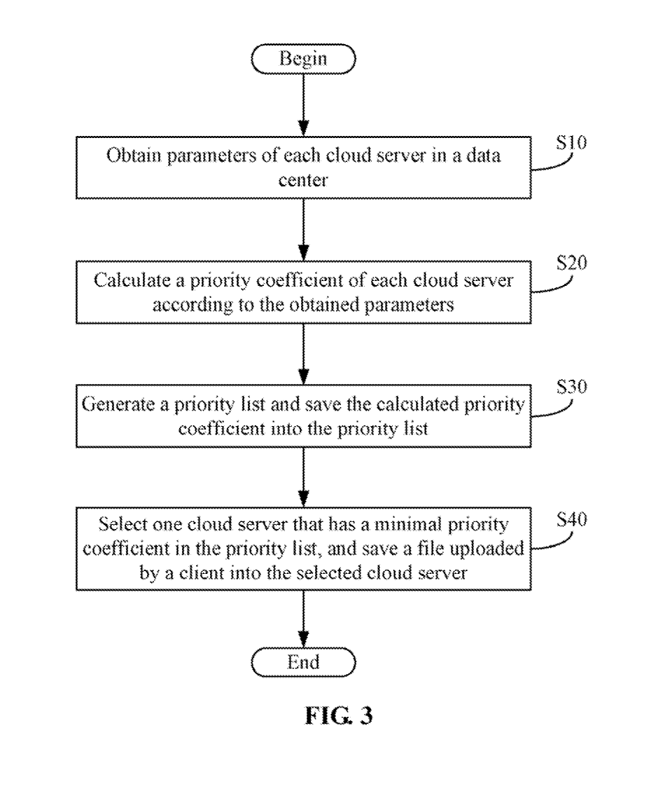

FIG. 3 is a flowchart of one embodiment of a file uploading method. Depending on the embodiment, additional steps may be added, others deleted, and the sequence of the steps may be changed.

In step S10, the obtaining module 210 obtains parameters of each cloud server 500. In one embodiment, the obtaining module 210 obtains the parameters of each cloud server 500 from a task manager of an operating system installed in the cloud server 500. Additionally, the parameters of each cloud server 500 are obtained at a time interval (e.g., one day).

In step S20, the calculation module 220 calculates a priority coefficient of each cloud server 500 according to the obtained parameters of the cloud server 500. As mentioned above, the priority coefficient indicates a priority for saving a file. The greater the priority coefficient is, the more load percentages (e.g., CPU utilization ratio) the cloud server 500 has. The priority coefficient of the cloud server 500 is calculated by the formula H as mentioned above. For example, the priority coefficient of the cloud server T1 is calculated as 158.4 according to the formula H. The priority coefficient of the cloud server T2 is calculated as 116.5 according to the formula H. The priority coefficient of the cloud server T3 is calculated as 186 according to the formula H. The priority coefficient of the cloud server T4 is calculated as 85 according to the formula H. Because the parameters of each cloud server 500 are obtained at a time interval (e.g., one day), the priority coefficient of each cloud server 500 is also calculated at the time interval.

In step S30, the generation module 230 generates a priority list 1000 and saves the calculated priority coefficient into the priority list 1000. As shown in FIG. 4, four priority coefficients 158.4, 116.5, 186, and 85 are saved into the priority list 1000.

Additionally, the priority list 1000 is updated in real time. For example, if the priority coefficient of the cloud server T1 is changed to 123.4, the priority coefficient 158.4 in the priority list 1000 is replaced by the priority coefficient 123.4.

In step S40, the uploading module 240 selects a cloud server 500 that has a minimum priority coefficient for saving a file uploaded by the client 10. For example, as shown in FIG. 4, the minimum priority coefficient is 85, so that the cloud server 500 corresponding to the minimum priority coefficient is T4, and the file is saved into the cloud server T4.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A monitoring computer, the monitoring computer in communication with cloud servers of a data center, comprising:
a storage system;
at least one processor; and
a storage system that stores one or more programs, when executed by the at least one processor, cause the at least one processor to perform a file uploading method, the method comprising:
obtaining parameters of the cloud servers;
calculating a priority coefficient of each cloud server according to the obtained parameters of the cloud servers;
generating a priority list and saving the calculated priority coefficients of the cloud servers into the priority list; and
selecting one cloud server that has a minimal priority coefficient in the priority list, and saving a file uploaded by a client into the selected cloud server.

2. The monitoring computer of claim 1, wherein the parameters of each cloud server comprises a total storage of the cloud server, an available storage of the cloud server, a memory utilization rate of the cloud server, a CPU utilization rate of the cloud server, a continuous operation time of the cloud server, a total number of files stored in the cloud server, and a usage storage of the files stored in the cloud server.

3. The monitoring computer of claim 1, wherein the parameters of each cloud server are obtained from a task manager of an operating system installed in the cloud server.

4. The monitoring computer of claim 2, wherein the priority coefficient of each cloud server is calculated by a formula H=[(B/A)+C+D]*(M+N+P), wherein H represents the priority coefficient, B represents the available storage of the cloud server, A represents the total storage of the cloud server, C represents the memory utilization rate of cloud server, D represents the CPU utilization rate of the cloud server, M represents the continuous operation time of the cloud server, N represents the total number of the files stored in the cloud server, and P represents the usage storage of the files stored in the cloud server.

5. A file uploading method implemented by a monitoring computer, the monitoring computer in electronic communication with cloud servers of a data center, the method comprising:
obtaining parameters of the cloud servers;
calculating a priority coefficient of each cloud server according to the obtained parameters of the cloud servers;
generating a priority list and saving the calculated priority coefficients of the cloud servers into the priority list; and
selecting one cloud server that has a minimal priority coefficient in the priority list, and saving a file uploaded by a client into the selected cloud server.

6. The method of claim 5, wherein the parameters of each cloud server comprises a total storage of the cloud server, an available storage of the cloud server, a memory utilization rate of the cloud server, a CPU utilization rate of the cloud server, a continuous operation time of the cloud server, a total number of files stored in the cloud server, and a usage storage of the files stored in the cloud server.

7. The method of claim 5, wherein the parameters of each cloud server are obtained from a task manager of an operating system installed in the cloud server.

8. The method of claim 6, wherein the priority coefficient of each cloud server is calculated by a formula H=[(B/A)+C+D]*(M+N+P), wherein H represents the priority coefficient, B represents the available storage of the cloud server, A represents the total storage of the cloud server, C represents the memory utilization rate of the cloud server, D represents the CPU utilization rate of the cloud server, M represents the continuous operation time of the cloud server, N represents the total number of files stored in the cloud server, and P represents the usage storage of the files stored in the cloud server.

9. A non-transitory computer-readable medium having stored thereon instructions that, when executed by a monitoring computer, the monitoring computer in electronic communication with cloud servers of a data center, causing the cloud server to perform a file uploading method, the method comprising:
obtaining parameters of the cloud servers;
calculating a priority coefficient of each cloud server according to the obtained parameters of the cloud servers;
generating a priority list and saving the calculated priority coefficients of the cloud servers into the priority list; and
selecting one cloud server that has a minimal priority coefficient in the priority list, and saving a file uploaded by a client into the selected cloud server.

10. The medium of claim 9, wherein the parameters of each cloud server comprises a total storage of the cloud server, an available storage of the cloud server, a memory utilization rate of the cloud server, a CPU utilization rate of the cloud server, a continuous operation time of the cloud server, a total number of files stored in the cloud server, and a usage storage of the files stored in the cloud server.

11. The medium of claim 9, wherein the parameters of each cloud server are obtained from a task manager of an operating system installed in the cloud server.

12. The medium of claim 10, wherein the priority coefficient of each cloud server is calculated by a formula H=[(B/A)+C+D]*(M+N+P), wherein H represents the priority coefficient, B represents the available storage of the cloud server, A represents the total storage of the cloud server, C represents the memory utilization rate of the cloud server, D represents the CPU utilization rate of the cloud server, M represents the continuous operation time of the cloud server, N represents the total number of files stored in the cloud server, and P represents the usage storage of the files stored in the cloud server.
